(19) United States
(12) Patent Application Publication
(10) Pub. No.: US 2008/0169402 A1
(43) Pub. Date: Jul. 17, 2008

(54) OVERHEAD MOUNTED VIEWING SCREEN

(75) Inventor: Alan Sturt, West Bloomfield, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 11/623,274

(22) Filed: Jan. 15, 2007

(51) Int. Cl. F16M 13/00

(52) U.S. Cl. 248/326

(57) ABSTRACT

An overhead mounted view screen assembly is provided including a headliner mount assembly. A view screen component in include having a view screen surface, a lower screen edge, and a pair of screen side edges. A pair of extension mount arms include a left extension mount arm having a lower left arm portion mounted to the view screen component and an upper left arm portion rotatably engaged to the headliner mount assembly. A right extension mount arm includes a lower right arm portion mounted to the view screen component and an upper right arm portion rotatably engaged to the headliner mount assembly. The view screen component is movable between a storage position and an active position. A see-through zone is formed between the left extension mount arm and the right extension mount arm when in the active position to allow rear-view view window pass through.

### TECHNICAL FIELD

The present invention relates generally to an overhead mounted viewing screen assembly and more particularly to an automotive overhead mounted viewing screen with minimized intrusion into the rear-view view window.

### BACKGROUND OF THE INVENTION

Automotive entertainment system have an increasing presence in modern automotive design. Systems provide a wide range of options to automotive customers. These options range from multimedia players, game systems, GPS and navigation systems, and even internet access. A common thread among many of these systems is the requirement of a video display. Video displays, while popular and intensely useful, provide considerable design challenges for integration into a vehicles interior.

A common design challenge arising from video screen integration arises from the balance of convenient viewing positions versus available mounting locations. Mounting within the head restraints of a vehicle seat is one option. However, this mounting approach limits the availability of screen height adjustment often making viewing uncomfortable or difficult for passengers of varied stature. Low location mounting such as in seatbacks or lower storage compartments often results in uncomfortable viewing angles and has the potential to generate motion sickness in some individuals. Overhead mounting in a vehicles headliner often proves the most effective by allowing comfortable viewing and utilizing commonly underutilized space.

Overhead mounting, however, is not without its own challenges. The pull down screen often interferes with a driver's rear-view vision. In large vehicles such as minivans or SUVs, this may simply be a distraction and may be minimized through the use of smaller video screens. In smaller vehicles, however, the impact or rear vision may be significant and may constrain video screen size to levels unacceptable by consumers.

As such it would be highly desirable to have an overhead mounted video assembly that minimized the obstruction of driver rear view vision. It would also be highly desirable for such an overhead mounted video assembly to be capable of using larger video screens without obstruction. Finally, it would be highly desirable to have such an overhead assembly capable of use in smaller vehicles.

### SUMMARY OF THE INVENTION

In accordance with the desires of the present invention an overhead mounted view screen assembly is provided including a headliner mount assembly. A view screen component in include having a view screen surface, a lower screen edge, and a pair of screen side edges. A pair of extension mount arms include a left extension mount arm having a lower left arm portion mounted to the view screen component and an upper left arm portion rotatably engaged to the headliner mount assembly. A right extension mount arm includes a lower right arm portion mounted to the view screen component and an upper right arm portion rotatably engaged to the headliner mount assembly. The view screen component is movable between a storage position and an active position. A see-through zone is formed between the left extension mount arm and the right extension mount arm when in the active position to allow rear-view view window pass through.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an overhead mounted view screen assembly in accordance with the present invention.

FIG. 2 is an illustration of the overhead mounted view screen assembly illustrated in FIG. 1, the illustration illustrating an overhead representation of the rear-view view window.

FIG. 3 is an illustration of the overhead mounted view screen assembly illustrated in FIG. 2 the illustration illustrating a side representation of the rear-view view window.

FIG. 4 is an illustration of the overhead mounted view screen assembly illustrated in FIG. 2 the illustration illustrating an alternate side representation of the rear-view view window.

### DESCRIPTION OF PREFERRED EMBODIMENTS

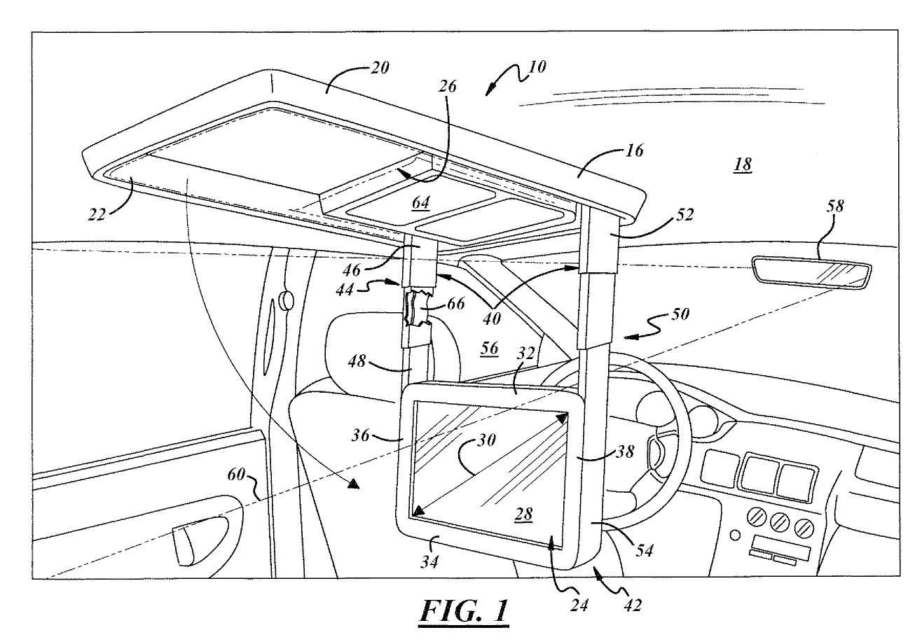

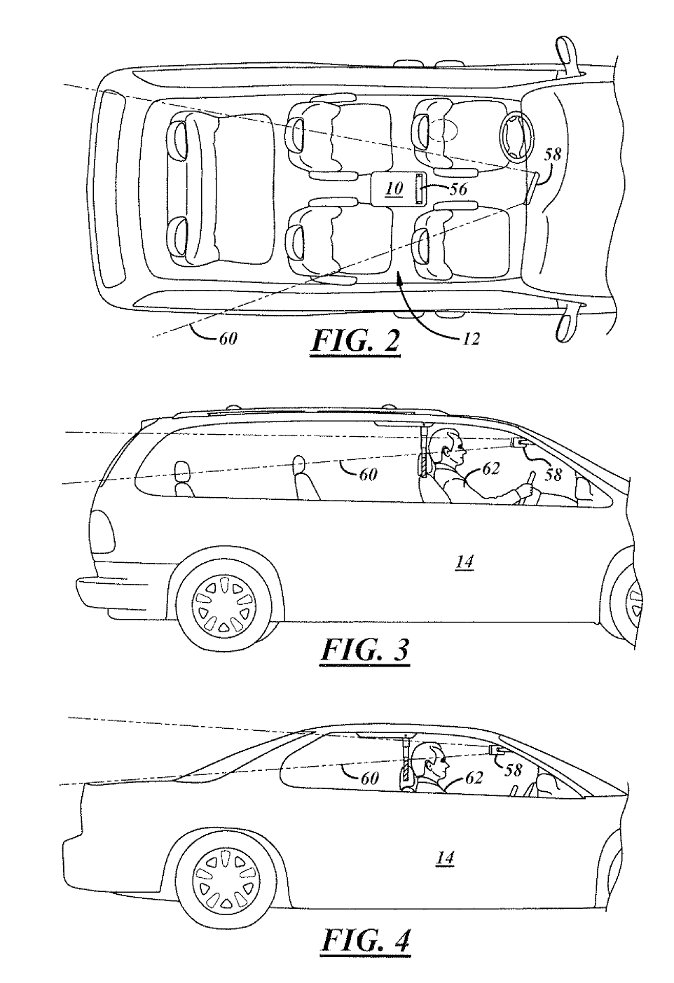

Referring now to FIG. 1, which is an illustration of an overhead mounted view screen assembly 10 in accordance with the present invention. The overhead mounted view screen assembly 10 is illustrated mounted within the interior 12 of an automobile 14. Although a particular vehicle is illustrated, it should be understood that the present invention is contemplated for use in a wide variety of vehicles. The present invention is particularly suited for smaller vehicles wherein view obstruction is a more significant consideration.

The overhead mounted view screen assembly 10 includes a headliner mount assembly 16 mounted to the vehicle headliner 18. The headliner mount assembly 16 may take on many configurations. In one embodiment the headliner mount assembly 16 comprises a rectangular mount frame 20 extending downwards from the headliner 18. In other embodiments, it is contemplated that the headliner mount assembly 16 may be formed flush or recessed into the headliner 18. The headliner mount assembly 16 preferably forms a storage chamber 22 configured to house a view screen component 24 in a storage position 26.

The view screen component 24 includes a view screen surface 28. A variety of view screen surfaces 28 are contemplated including, but not limited to, an led screen. The view screen surface 28 is defined by a screen size 30 preferably equal to or greater than nine inches. The view screen component 24 additionally includes an upper screen edge 32, a lower screen edge 34, a left screen side edge 36 and a right screen side edge 38. The view screen component 24 is attached to the headliner mount assembly 16 by way of a pair of extension mount arms 40 such that the view screen component 24 is positioned remotely from the headliner mount assembly 16 when in an active position 42. It is contemplated that the pair of extension mount arms 40 may comprise telescopic arms to facilitate vertical adjustment of the view screen component 24 to tailor to a wide variety of viewer statures.

The pair of extension mount arms 40 are comprised of a left extension mount arm 44 including a lower left arm portion 48 mounted to the view screen component 24 preferably in proximity to the left screen side edge 36. The upper left arm portion 46 is rotatably mounted to the headliner mount assembly 16 such that the view screen component 24 may be easily rotated from the storage position 22 into the active position 42. Similarly, the pair of extension mount arms 40 include a right extension mount arm 50 including a lower right arm portion 54 mounted to the view screen component 24 preferably in proximity to the right screen side edge 38. The right extension mount arm 50 also includes an upper right arm portion 52 rotatably mounted to the view screen component.

The space between the right extension mount arm 50, the left extension mount arm 44 and the upper screen edge 32 forms a see-through zone 56. This is highly beneficial as the rear view mirror 58 generates a rear-view view window 60 relative to the driver's 62 field of view. This rear-view view window 60 is the range of sight available to the driver 62 when looking in the rear view mirror 58. The see-through zone 58 allows the overhead mounted view screen assembly 10 to have a minimal impact on the rear-view view window 60. In one embodiment, it is contemplated that the pair of extension arms 40 will obstruct less than ten percent of the rear-view view window 60. In other embodiments, it is contemplated that this percentage will be less than twenty percent. In still another embodiment it is contemplated that the upper screen edge 32 will be positioned below the rear-view view mirror 60 when in the active position 42.

When the view screen component 24 is rotated up to a horizontal orientation and into the storage position 26, the see-through zone 58 is no longer necessary. Therefore, the present invention contemplates the use of a modular assembly 64 mounted within the headliner mount assembly 16. The modular assembly is 64 is configured to fit between the left extension mount arm 44, the right extension mount arm 50 and the upper screen edge 32 when the view screen component 24 is in the storage position 26. It is contemplated that the modular assembly 64 may comprise storage chambers, entertainment equipment such as a dvd player or game system, gps or navigation equipment, and/or a control device to manage content on the view screen component 24. In these embodiments, it is further contemplated that a wire harness 66 may be positioned within one of the pair of extension mount arms 40 to place the modular assembly 64 in communication with the view screen component 24.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An overhead mounted view screen assembly for mounting to a vehicle headliner comprising:
a headliner mount assembly;
a view screen component including a view screen surface, an upper screen edge, a lower screen edge, a left screen side edge, and a right screen side edge;
a pair of extension mount arms comprising:
a left extension mount arm including a lower left arm portion mounted to said view screen component in proximity to said left screen side edge and an upper left arm portion rotatably engaged to said headliner mount assembly;
a right extension mount arm including a lower right arm portion mounted to said view screen component in proximity to said right screen side edge and an upper right arm portion rotatably engaged to said headliner mount assembly;
wherein said view screen component is movable about said upper left arm portion and said upper right arm portion between a storage position and an active position, a see-through zone is formed between said left extension mount arm and said right extension mount arm when said view screen component is in said active position, said see-through zone configured to allow rear-view view window pass through.

2. An overhead mounted view screen assembly as described in claim 1, wherein said headliner mount assembly comprises:
a rectangular mount frame configured to house said view screen component when in said storage position.

3. An overhead mounted view screen assembly as described in claim 1, further comprising:
a modular assembly positioned within said headliner mount assembly, said modular assembly configured to fit between said left extension mount arm, said right extension mount arm and said upper screen edge when said view screen component is in said storage position.

4. An overhead mounted view screen assembly as described in claim 1, wherein said modular assembly comprises a storage compartment.

5. An overhead mounted view screen assembly as described in claim 1, wherein said modular assembly comprises an entertainment device.

6. An overhead mounted view screen assembly as described in claim 1, wherein said modular assembly comprises a control device.

7. An overhead mounted view screen assembly as described in claim 1, wherein said pair of extension mount arms generate less than ten percent rear-view view window blockage when said view screen component is in said active position.

8. An overhead mounted view screen assembly as described in claim 1, wherein said upper screen edge is configured to be below a rear-view view window when said view screen component is in said active position.

9. An overhead mounted view screen assembly as described in claim 1, wherein said pair of extension mount arms comprise telescopic mount arms configured to allow vertical adjustment of said view screen component when in said active position.

10. An overhead mounted view screen assembly as described in claim 1, wherein said view screen surface comprises a screen size equal to or greater than nine inches.

11. An overhead mounted view screen assembly as described in claim 5, further comprising
a wire harness positioned within one of said pair of extension mount arms, said wire harness placing said modular assembly in communication with said view screen component.

12. An overhead mounted view screen assembly comprising:
a headliner mount assembly mounted to a vehicle headliner rearward of a rear-view mirror, said rear-view mirror having a rear-view view window;
a view screen component including a view screen surface, an upper screen edge, a lower screen edge, a left screen side edge, and a right screen side edge;
a pair of extension mount arms comprising:
a left extension mount arm including a lower left arm portion mounted to said view screen component in proximity to said left screen side edge and an upper left arm portion rotatably engaged to said headliner mount assembly;
a right extension mount arm including a lower right arm portion mounted to said view screen component in proximity to said right screen side edge and an upper right arm portion rotatably engaged to said headliner mount assembly;
wherein said view screen component is movable about said upper left arm portion and said upper right arm portion between a storage position wherein said view screen surface is horizontally orientated and an active position wherein said view screen surface is vertically orientated, a see-through zone is formed between said left extension mount arm and said right extension mount arm when said view screen component is in said active position, said see-through zone positioned in said rear-view view window.

13. An overhead mounted view screen assembly as described in claim 12, further comprising:
a modular assembly positioned within said headliner mount assembly, said modular assembly configured to fit between said left extension mount arm, said right extension mount arm and said upper screen edge when said view screen component is in said storage position;
said headliner mount assembly comprising a rectangular mount frame configured to house said view screen component when in said storage position.

14. An overhead mounted view screen assembly as described in claim 13, wherein said modular assembly comprises an entertainment device.

15. An overhead mounted view screen assembly as described in claim 14, further comprising
a wire harness positioned within one of said pair of extension mount arms, said wire harness placing said entertainment device in communication with said view screen component.

16. An overhead mounted view screen assembly as described in claim 12, wherein said upper screen edge is configured to be below said rear-view view window when said view screen component is in said active position.

17. An overhead mounted view screen assembly as described in claim 12, wherein said pair of extension mount arms and said view screen component generate less than twenty percent rear-view view window blockage when said view screen component is in said active position.

18. An overhead mounted view screen assembly as described in claim 12, wherein said pair of extension mount arms comprise telescopic mount arms configured to allow vertical adjustment of said view screen component when in said active position.

19. A method of providing entertainment within an automotive interior comprising:
mounting an overhead mounted screen assembly to a vehicle headliner rearward of a rearview mirror, said rearview mirror having a rear-view view window, said overhead mounted screen assembly comprising:
a headliner mount assembly mounted to said vehicle headliner;
a view screen component including a view screen surface, an upper screen edge, a lower screen edge, a left screen side edge, and a right screen side edge;
a pair of extension mount arms comprising:
a left extension mount arm including a lower left arm portion mounted to said view screen component in proximity to said left screen side edge and an upper left arm portion rotatably engaged to said headliner mount assembly;
a right extension mount arm including a lower right arm portion mounted to said view screen component in proximity to said right screen side edge and an upper right arm portion rotatably engaged to said headliner mount assembly;
wherein said view screen component is movable about said upper left arm portion and said upper right arm portion between a storage position and an active position, a see-through zone is formed between said left extension mount arm and said right extension mount arm when said view screen component is in said active position, said see-through zone configured position in said rear-view view window.

20. A method as described in claim 19, wherein said pair of extension mount arms comprise telescopic mount arms configured to allow vertical adjustment of said view screen component when in said active position.
